(19) United States
(12) Patent Application Publication
(10) Pub. No.: US 2013/0291567 A1
(43) Pub. Date: Nov. 7, 2013

(54) Regasification Plant

(71) Applicants: Lalit Kumar Bohra, Houston, TX (US); David P. O'Brien, Houston, TX (US); Franklin F. Mittricker, Jamul, CA (US); Mark L. Merrifield, Houston, TX (US)

(72) Inventors: Lalit Kumar Bohra, Houston, TX (US); David P. O'Brien, Houston, TX (US); Franklin F. Mittricker, Jamul, CA (US); Mark L. Merrifield, Houston, TX (US)

(21) Appl. No.: 13/979,626

(22) PCT Filed: Jan. 9, 2012
(86) PCT No.: PCT/US12/20643

§ 371 Date: Jul. 12, 2013

Related U.S. Application Data
(60) Provisional application No. 61/567,818, filed on Dec. 7, 2011.
(60) Provisional application No. 61/437,391, filed on Jan. 28, 2011.

(51) Int. Cl. F17C 9/04

(52) U.S. Cl. CPC F17C 9/04
USPC 62/48.1

(57) ABSTRACT

Methods and systems for regasifiing LNG are provided. A method for regasifying liquefied natural gas (LNG) includes providing heat to a LNG regasification process from a power plant. If the heat is not sufficient, additional heat can be provided to the LNG regasification process from a cooling tower operated in a warming tower configuration.

### CROSS REFERENCE TO RELATED APPLICATIONS

This application claims priority to U.S. Provisional patent application 61/437,392 entitled REGASIFICATION PLANT which was filed on Jan. 28, 2011, and U.S. Provisional patent application 61/567,818 entitled REGASIFICATION PLANT which was filed on Dec. 7, 2011 the entirety of which is included herein.

### FIELD

Exemplary embodiments of the present techniques relate to a liquefied natural gas terminal with flexible capability to provide pipelined natural gas, electricity to a grid, or both.

### BACKGROUND

Large volumes of natural gas (i.e., primarily methane) are located in remote areas of the world. This gas has significant value if it can be economically transported to market. Where the gas reserves are located in reasonable proximity to a market and the terrain between the two locations permits, the gas is typically produced and then transported to market through submerged and/or land-based pipelines. However, when gas is produced in locations where laying a pipeline is infeasible or economically prohibitive, other techniques must be used for getting this gas to market.

A commonly used technique for non-pipeline transport of gas involves liquefying the gas at or near the production site and then transporting the liquefied natural gas to market in specially-designed storage tanks aboard transport vessels. The natural gas is cooled and condensed to a liquid state to produce liquefied natural gas (“LNG”). LNG is often transported at substantially atmospheric pressure and at temperatures of about −162° C. (−260° F.), thereby significantly increasing the amount of gas which can be stored in a particular storage tank on a transport vessel. Once a LNG transport vessel reaches its destination, the LNG is typically off-loaded into other storage tanks from which the LNG can then be revaporized as needed and transported as a gas to end users through pipelines or the like. Natural gas is used for various purposes one of them being power generation. LNG has been an increasingly popular transportation method to supply major energy-consuming nations with natural gas.

During the regasification process, natural gas temperature changes from about −162° C. to up to about 15° C. depending on sales specification. Required heat for regasification is typically supplied by burning some of the product natural gas in fuel-fired vaporizers such as Submerged Combustion Vaporizers (SCVs) or Shell-and-Tube Vaporizers (STVs) with Fired Heaters. These fuel-fired vaporizers consume about 1.5-2.0% of product natural gas as the fuel. The fuel consumption not only results in large operating expenses by consuming some of the product itself but also in large environmental emissions in the form of CO₂ and NOₓ. Using other sources of heat such as sea water and ambient air may reduce the terminal emissions but these have their own limitations. For example, use of sea water requires large capital investment and may adversely affect marine life due to very large quantities of sea water required and cold temperature discharge. At many locations, the process to obtain permit to use sea water from regulatory authorities could be very elaborate. Use of ambient air heat may be a viable option only in hot climates; even there benefit is greatly reduced by daily and seasonal variation in temperature and humidity.

The general methods discussed above utilize various heat sources to capture the cold contained in LNG, which could be used for reducing emissions, improving process efficiencies and economics of the LNG receiving terminal. Therefore, research efforts have focused on finding methods that not only reduce fuel consumption thereby reducing operating expenses and emissions associated with LNG regasification process, for example, by utilizing the LNG cold.

Several methods have been proposed in the prior art to address the issues of reducing emissions, and to use LNG cold to some advantage. One such method includes integrating LNG regasification with power generation. One efficient power generation method is the combined cycle power plant (CCGT). A CCGT plant includes gas turbine generator (GTG), which may further include compressors, combustors, gas turbines (GT), and the like. A heat recovery unit (HRU) can then be used to recover the exhaust heat from the gas turbine. An example of an HRU is a heat recovery steam generator (HRSG). The HRSG uses exhaust heat from the GTs for steam generation, and then sends the steam through a steam turbine generator (STG), and steam condenser. The steam condenser may use cooling from the LNG regasification for the condensation. Further, CCGT can include a cooling tower to provide coolant to a steam condenser.

The use of LNG cold to cool the inlet air in a gas turbine based power plant or condensing steam exiting steam turbine from a combined cycle power plant has been disclosed in the art. For example, U.S. Pat. No. 7,574,856, by Mak, discloses power generation integrated with LNG regasification. The cold from the LNG is used in a combined power plant to increase power output. In configurations, a first stage LNG cold provides cooling to an open or closed power cycle. A portion of the LNG is vaporized in the first stage. In a second stage, the cold from the LNG provides cooling for a heat transfer medium that is used to provide refrigeration for the cooling water to a steam power turbine and for an air intake chiller of a combustion turbine in the power plant.

U.S. Pat. No. 7,299,619 by Briesch, et al., discloses the using the vaporization of LNG to increase efficiency in power cycles. Inlet air chilling for a gas turbine is provided by the vaporization of the LNG. The cycle uses regeneration for preheating of combustor air. The process offers the potential efficiencies for the gas turbine cycle in excess of 60%. The systems and methods permit the vaporization of LNG using ambient air, with the resulting super cooled air being easier to compress. In alternative embodiments, the vaporization of the LNG may be used as part of a bottoming cycle to increase the efficiencies of the gas turbine system.

U.S. Patent Application Publication No. 2003/0005698 by Keller discloses a process and system for LNG regasification. The system for vaporizing the LNG utilizes the residual cooling capacity of the LNG to condense the working fluid of a power producing cycle. The LNG can also chill liquids that are used in a direct-contact heat transfer system to cool air. The cold air is used to supply air to a combustion gas turbine operating in conjunction with a combined cycle power plant.

U.S. Pat. No. 6,367,258 to Wen, et al., discloses vaporizing LNG in a combined cycle power plant. The efficiency of the combined cycle generation plant can be increased by using the vaporization of cold liquid including liquefied natural gas (“LNG”) or liquefied petroleum gas (LPG). The vaporization is assisted by circulating a warm heat transfer fluid to transfer heat to a LNG/LPG vaporizer. The heat transfer fluid is chilled by LNG/LPG cold liquid vaporization and warmed by heat from a gas turbine. The heat transfer fluid absorbs heat from the air intake of a gas turbine and from a secondary heat transfer fluid circulating in a combined cycle power plant.

There is potential to eliminate fuel consumption associated with LNG regasification if a large enough power plant could be installed at the LNG regasification location. This scheme also improves efficiency of the power plant and the power output by cooling the turbine inlet air and providing a colder cooling medium to the steam turbine condenser. LNG cold may also be used in the intercoolers for the compressor of the GTG.

Another method to reduce emissions from a LNG terminal is use of ambient air heat for LNG regasification. Since use of ambient air heat reduces fuel consumption, the terminal economics may improve considerably. There are multiple types of ambient air vaporizers, including, for example, a direct type (both natural and forced draft), a fin-fan (similar to air coolers), and a warming tower (also known as a “reverse cooling tower” or “heating tower”). The use of a warming tower has been described in prior art for LNG regasification.

For example, U.S. Pat. No. 6,644,041, to Eyermann, discloses the vaporization of liquefied natural gas using a water tower. A temperature of a water stream may be increased in the water tower. The warmed water can be passed through a first heat exchanger, and a circulating fluid may also be passed through the first heat exchanger so as to transfer heat from the warmed water into the circulating fluid. The LNG may be passed into a second heat exchanger, and the heated circulating fluid from the first heat exchanger may be passed through the second heat exchanger so as to transfer heat from the circulating fluid to the LNG gas. The vaporized natural gas is discharged from the second heat exchanger.

Further, U.S. Pat. No. 7,137,623 to Mockry, et al., discloses a heating tower that isolates outlet and inlet air. The heating tower may be used to heat a fluid by drawing an air stream into the heating tower through an inlet and passing the air stream over a fill medium. A fluid is passed over the fill medium along with discharging the air stream from the heating tower through an outlet. The method further includes isolating the inlet air stream from the outlet air stream.

In the techniques discussed above, a power plant integrated with a LNG regasification process can decrease emissions and utilize LNG cold, while use of a warming tower for LNG regasification addresses only emissions issue. However, the size of a power plant will be very large to fully utilize the cold from the LNG. For example, for 2 BCFD (billion cubic feet per day) of natural gas sales may require that the power plant be around 500 MW to utilize the cold. This size of plant would represent a very large capital expenditure. Further, a large market would be needed for the electricity produced by the plant.

Both the power plant and warming tower options become less attractive if there is not enough demand for natural gas, which may occur seasonally. Less demand for natural gas means there is less cold available from the LNG, Less available cold reduces the operational efficiency of installed equipment. The use of a warming tower can be further constrained by prevailing ambient conditions, such as temperature and humidity. Therefore, both of the above mentioned techniques provide only partial solutions without any flexibility in utilizing LNG cold.

Related information may be found in U.S. Pat. Nos. 5,295,350; 5,457,951; 6,324,867; 6,367,258; 6,374,591; 7,299,619; and 7,644,573. Further information may also be found in U.S. Patent Application Publication Nos. 2003/0005698, 2008/0307789, 2008/0034727, 2008/0047280, 2008/0178611, 200810190106, 200810250795, 200810276617, and 2008/0307789, Further information may also be found in Rosetta, and Himmelberger, “Integrating Ambient Air Vaporization Technology with Waste Heat Recovery—A Fresh Approach to LNG Vaporization,” presented at the 85^{th} annual convention of the Gas Processors of America (GPA 2006), Grapevine, Tex., Mar. 5-8, 2006; Cho, J. H.; Ebbern, D., Kotzot, H., and Durr, C., “Marrying LNG and Power Generation,” Energy Markets; October/November 2005; 10, 8; ABI/INFORM Trade & Industry, p. 28; Rajeev Nanda and John Rizopoulos, “Utilizing Air Based Technologies as Heat Source for LNG Vaporization,” presented at the 86th Annual convention of the Gas Processors of America (GPA 2007), Mar. 11-14, 2007, San Antonio, Tex.

### SUMMARY

An exemplary embodiment provides a method for regasifying liquefied natural gas (LNG). The method includes providing heat to a LNG regasification process from a power plant. If the heat is not sufficient, additional heat may be provided to the LNG regasification process from a cooling tower operated in a warming tower configuration.

The method may include cooling water in the cooling tower when the power plant is operational. The cooling tower may be used to warm a heat transfer fluid. Intake air for a gas turbine may be chilled by transferring heat to the LNG regasification process. Steam from a steam turbine may be condensed in a heat exchanger by transferring energy to the LNG regasification process.

Energy from the power plant may be transferred to the LNG regasification process through a heat transfer fluid. At least a portion of the heat transfer fluid may be heated against an inlet air stream for a gas turbine. At least a portion of the heat transfer fluid may be heated against condensing steam in the power plant.

Another embodiment provides a method for vaporizing a cryogenic fluid. The method includes vaporizing the cryogenic fluid against a heat transfer fluid and providing heat energy to the heat transfer fluid from a power plant. If the heat from the power plant is not sufficient to vaporize the cryogenic fluid, heat energy is provided to the heat transfer fluid from a cooling tower of the power plant operating in a warming mode.

At least a portion of the heat transfer fluid may be heated against an inlet air stream for a gas turbine. At least a portion of the heat transfer fluid may be heated against a condensing fluid in a power plant.

Another embodiment provides a system for regasifying liquefied natural gas. The system includes a cryogenic heat exchanger configured to regasify a stream of LNG, a power plant, a cooling tower configured to operate in either a cooling or a warming mode, and a heat transfer fluid. The heat transfer fluid is configured to provide heat to the cryogenic heat exchanger from the power plant, and, if the heat is not sufficient, provide at least a portion of the heat to the cryogenic heat exchanger from the cooling tower.

The system may include an intermediate heat exchanger configured to transfer the heat from the cooling tower to the heat transfer fluid. The intermediate heat exchanger may be a plate-frame type, a shell-and-tube type, a tube-in-tube type, or a plate and shell type, or any combinations thereof.

The power plant may be a combined cycle power plant, including a gas turbine generator and a heat recovery steam generator. The system may include an inlet air cooler on a gas turbine generator configured to transfer the heat to the heat transfer fluid. The system may include a steam condenser, and a heat exchanger configured to transfer heat energy from the steam condenser to the heat transfer fluid. The power plant may include a steam generator, a steam turbine generator, a steam condenser, and a recirculation pump. The power plant may be a geothermal power plant. The geothermal power plant may include a binary cycle power plant.

The heat transfer fluid may be a single-phase fluid, such as water or a water/glycol mixture. The heat transfer fluid may be a phase-change fluid, such as propane, freon, a phase change refrigerant, or any combinations thereof.

### DESCRIPTION OF THE DRAWINGS

The advantages of the present techniques are better understood by referring to the following detailed description and the attached drawings, in which:

FIG. 1 is a block diagram of a combined LNG terminal/power plant, illustrating the use of heat from the power plant to regasify LNG;

FIG. 2 is a block diagram describing one system for using heat from the power plant to vaporize LNG;

FIG. 3 is a process flow diagram of a LNG regasification method that can be used in the systems discussed above;

FIG. 4 is a process flow diagram of a combined plant having both a LNG regasification process and a combined cycle power plant;

FIG. 5 is a process flow diagram of a combined plant having both a LNG regasification process and a combined cycle power plant, using no separate intermediate heat transfer fluid;

FIG. 5A is a process flow diagram of a combined plant having both a LNG regasification process and a combined cycle power plant using an intermediate heat transfer fluid on the LNG regasification side; and

FIG. 6 is a process flow diagram of a combined plant having a LNG regasification plant in combination with a steam power plant.

### DETAILED DESCRIPTION

In the following detailed description section, specific embodiments of the present techniques are described. However, to the extent that the following description is specific to a particular embodiment or a particular use of the present techniques, this is intended to be for exemplary purposes only and simply provides a description of the exemplary embodiments. Accordingly, the techniques are not limited to the specific embodiments described below, but rather, include all alternatives, modifications, and equivalents falling within the true spirit and scope of the appended claims.

At the outset, for ease of reference, certain terms used in this application and their meanings as used in this context are set forth. To the extent a term used herein is not defined below, it should be given the broadest definition persons in the pertinent art have given that term as reflected in at least one printed publication or issued patent. Further, the present techniques are not limited by the usage of the terms shown below, as all equivalents, synonyms, new developments, and terms or techniques that serve the same or a similar purpose are considered to be within the scope of the present claims.

A “binary cycle power plant” is a type of power plant that allows cooler geothermal reservoirs to be used than for steam power plants. In binary cycle geothermal power plants, pumps are used to pump hot water from a geothermal well, through a heat exchanger, and the cooled water is returned to the underground reservoir. A secondary circulation fluid having a low boiling point, such as butane, isobutane, pentane, an alcohol, or a ketone, is pumped through the heat exchanger, where it is vaporized against the hot water from the geothermal reservoir, and then directed through a turbine. The vapor exiting the turbine is then condensed against a condensing fluid, such as a heat transfer fluid or cold water, and cycled back through the heat exchanger. The efficiency of the binary cycle power plant may increase with the temperature differential between the geothermal reservoir and the condensing fluid.

A “combined cycle power plant” includes a gas turbine, a steam turbine, a generator, and a heat recovery steam generator (HRSG), and uses both steam and gas turbines to generate power. The gas turbine operates in an open Brayton cycle, and the steam turbine operates in a Rankine cycle. Typically, combined cycle power plants utilize heat from the gas turbine exhaust to boil water in the heat recovery steam generator (HRSG) to generate steam. The steam generated is utilized to power the steam turbine. After powering the steam turbine, the steam may be condensed and the resulting water returned to the HRSG. The gas turbine and the steam turbine can be utilized to separately power independent generators, or in the alternative, the steam turbine can be combined with the gas turbine to jointly drive a single generator via a common drive shaft. These combined cycle gas/steam power plants generally have higher energy conversion efficiency than gas or steam only plants. A combined cycle plant's efficiencies can be as high as 50% to 60%. The higher combined cycle efficiencies result from synergistic utilization of a combination of the gas turbine with the steam turbine.

As used herein, a “cryogenic fluid” includes any fluid with a boiling point of less than about −130° C. at ambient pressure conditions. Such fluids may include liquefied natural gas (LNG), liquid nitrogen, liquid oxygen, liquid hydrogen, liquid helium, liquid carbon dioxide, and the like.

The term “gas” is used interchangeably with “vapor,” and means a substance or mixture of substances in the gaseous state as distinguished from the liquid or solid state. Likewise, the term “liquid” means a substance or mixture of substances in the liquid state as distinguished from the gas or solid state.

A “hydrocarbon” is an organic compound that primarily includes the elements hydrogen and carbon although nitrogen, sulfur, oxygen, metals, or any number of other elements may be present in small amounts. As used herein, hydrocarbons generally refer to organic materials that are harvested from hydrocarbon containing sub-surface rock layers, termed reservoirs. For example, natural gas is a hydrocarbon.

“Liquefied natural gas” or “LNG” is cryogenic liquid form of natural gas generally known to include a high percentage of methane, but also other elements and/or compounds including, but not limited to, ethane, propane, butane, carbon dioxide, nitrogen, helium, hydrogen sulfide, or combinations thereof. The natural gas may have been processed to remove one or more components (for instance, helium) or impurities (for instance, water and/or heavy hydrocarbons) and then condensed into the liquid at almost atmospheric pressure by cooling.

The term “natural gas” refers to a multi-component gas obtained from a crude oil well (associated gas) or from a subterranean gas-bearing formation (non-associated gas). The composition and pressure of natural gas can vary significantly. A typical natural gas stream contains methane (C₁) as a significant component. Raw natural gas may also contain ethane (C₂), higher molecular weight hydrocarbons, acid gases (such as carbon dioxide, hydrogen sulfide, carbonyl sulfide, carbon disulfide, and mercaptans), and minor amounts of contaminants such as water, nitrogen, iron sulfide, wax, and crude oil. As used herein, natural gas includes gas resulting from the regasification of a liquefied natural gas, which has been purified to remove contaminates, such as water, acid gases, and most of the higher molecular weight hydrocarbons.

“Pressure” is the force exerted per unit area by the gas on the walls of the volume. Pressure can be shown as pounds per square inch (psi). “Atmospheric pressure” refers to the local pressure of the air. “Absolute pressure” (psia) refers to the sum of the atmospheric pressure (14.7 psia at standard conditions) plus the gage pressure (psig). “Gauge pressure” (psig) refers to the pressure measured by a gauge, which indicates only the pressure exceeding the local atmospheric pressure (i.e., a gauge pressure of 0 psig corresponds to an absolute pressure of 14.7 psia). The term “vapor pressure” has the usual thermodynamic meaning. For a pure component in an enclosed system at a given pressure, the component vapor pressure is essentially equal to the total pressure in the system.

As used herein, a “Rankine power plant” includes a steam generator, a steam turbine, a steam condenser, and a recirculation pump. The steam generator is often a gas fired boiler that boils water to generate the steam. However, in embodiments, the steam generator may be a geothermal energy source, such as a hot rock layer in a subsurface formation. The steam is used to generate electricity in the steam turbine generator, and the reduced pressure steam is then condensed in the steam condenser. The resulting water is recirculated to the steam generator to complete the loop.

“Substantial” when used in reference to a quantity or amount of a material, or a specific characteristic thereof, refers to an amount that is sufficient to provide an effect that the material or characteristic was intended to provide. The exact degree of deviation allowable may in some cases depend on the specific context.

### Overview

Embodiments described herein provide liquid natural gas (LNG) regasification techniques and systems that reduce emissions associated with fuel-fired vaporizers and improve the flexibility of utilizing LNG cold. In an embodiment, LNG is regasified using heat available from gas turbine inlet air cooling or inter-cooling and heat from steam condenser of combined cycle power plant. In some embodiments, an intermediate heat transfer fluid (HTF) may transfer heat from a power plant or water tower to LNG vaporizers.

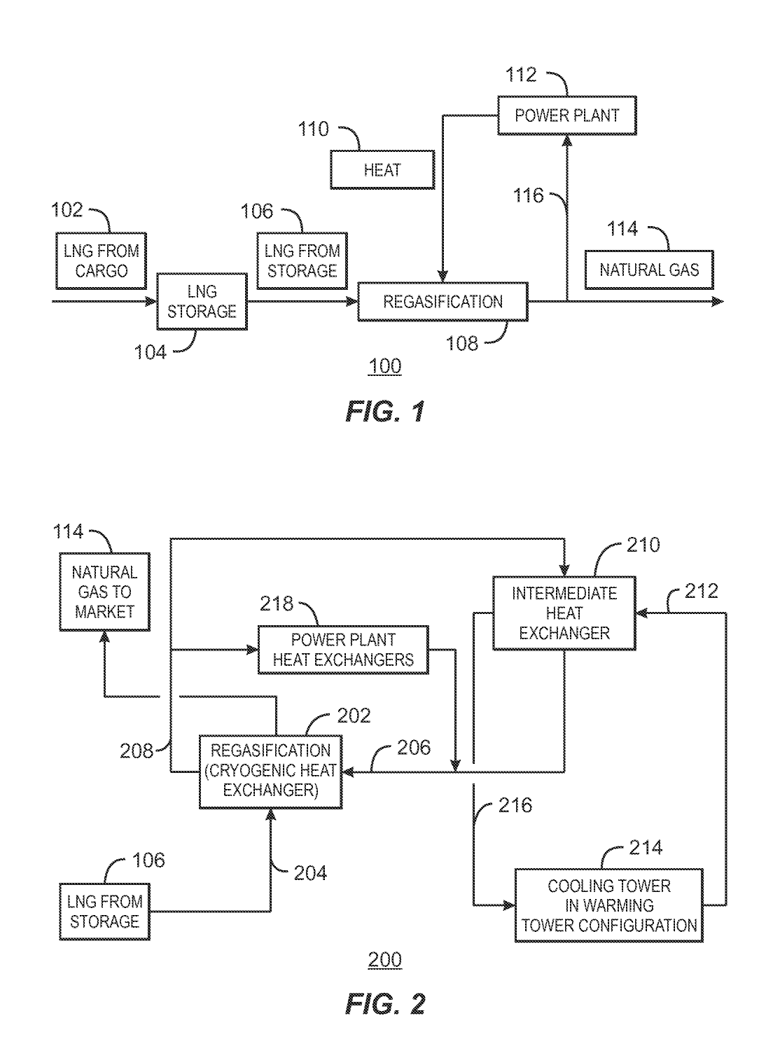

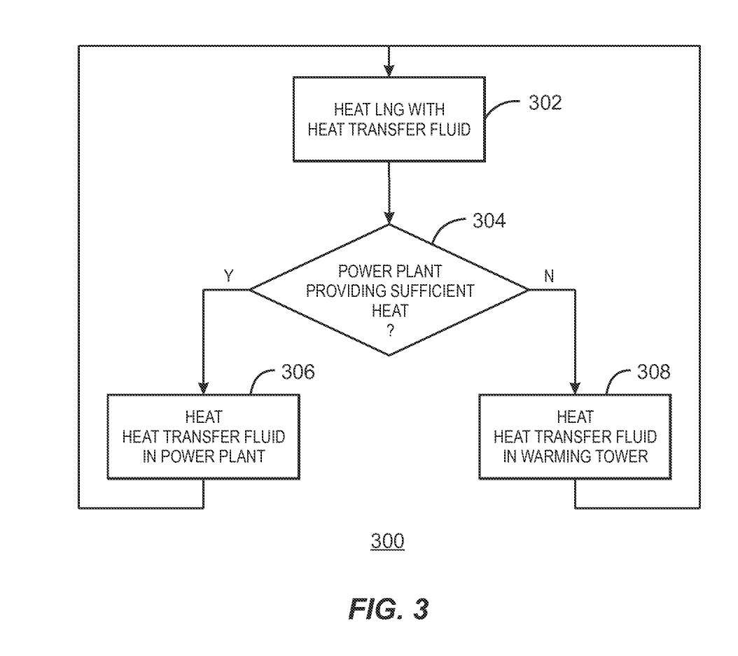

FIG. 1 is a block diagram of a combined LNG terminal/power plant 100, illustrating the use of heat from the power plant to regasify LNG. In the LNG terminal/power plant 100, LNG 102 from a cargo vessel may be unloaded to a LNG storage system 104, which may include cryogenic tanks or the vessels themselves. The LNG from storage 106 may be transferred from the LNG storage system 104 through a regasification process 108, in which heat 110 from a power plant 112 may be used to assist with the regasification. The resulting natural gas 114 may be provided to market. Further, a portion 116 of the natural gas may be diverted to the power plant 112 to be used as fuel. In the configurations described herein, the power plant may not need to be sized for full terminal capacity in order to utilize all the waste heat available. The transfer of heat is discussed in more detail with respect to FIG. 2.

FIG. 2 is a block diagram describing one system 200 for using heat from the power plant to vaporize LNG. It will be dear that other system arrangements may be used in embodiments, as described below. Like numbers are as described with respect to FIG. 1. As described with respect to FIG. 1, LNG from storage 106 may be passed through a regasification process 108, such as being vaporized in a cryogenic heat exchanger 202. The cryogenic heat exchanger 202 may include a shell-and-tube heat exchanger, or any number of other types of heat exchangers, in which the liquid LNG 204 is vaporized against the energy of a heat transfer fluid 206. The resulting cooled intermediate fluid 208 may be heated in an intermediate heat exchanger 210 against warm water 212 coming from a cooling tower 214, e.g., operating in a warming tower configuration.

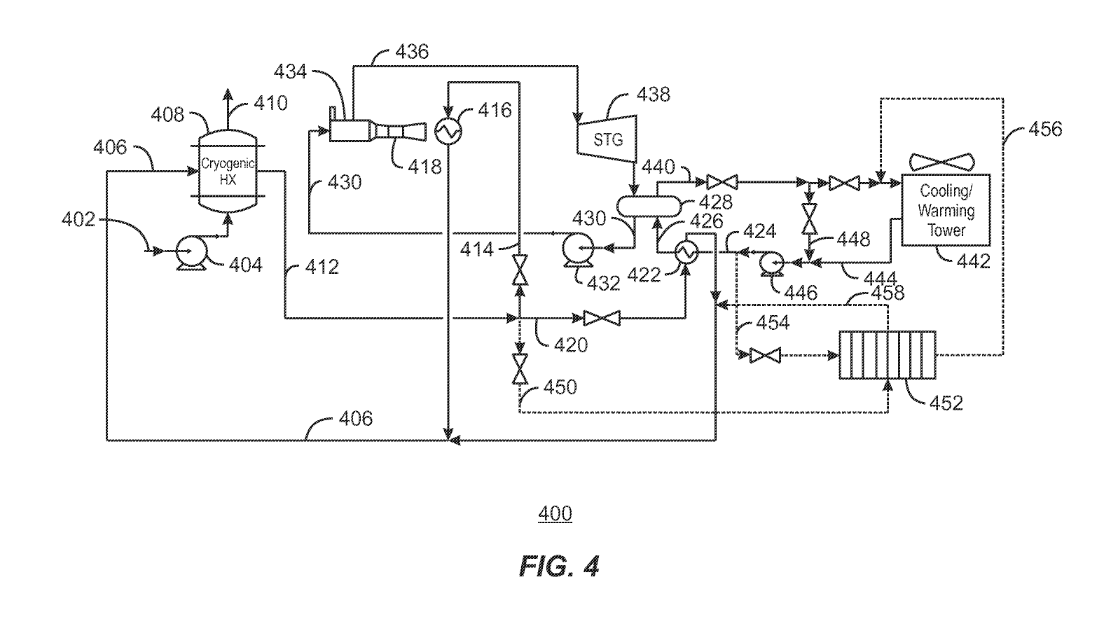

In the cooling tower 214, the cold water 216 coming from the intermediate heat exchanger 210 can be warmed against ambient air or against heat energy coming from a power plant, or both. The cooling tower 214 may be a falling water or evaporative type cooling tower, a fin-fan cooling tower, or any other type of cooling tower that may be operated to warm a fluid against an ambient air flow. The cooling tower 214 may be redesigned so that it can be operate in both cooling and warming modes. The cooled intermediate fluid 208 may also be heated in heat exchangers 218 in the power plant. These heat exchangers 218 may include heat exchangers on the inlet air to gas turbines, on intercoolers for the gas turbines, on exhaust separation units used for CO₂ sequestration processes, on steam condensers, or on any other heat sources in the power plant. During periods when the power plant is not providing sufficient heat energy, the cooling tower 214 of the power plant may provide the excess heat used to regasify the LNG 204. This can reduce the initial capital expenditure associated with the power plant. The systems discussed above provide a flexible capacity for providing heat to a LNG gasification process, for example, using the method discussed with respect to FIG. 3.

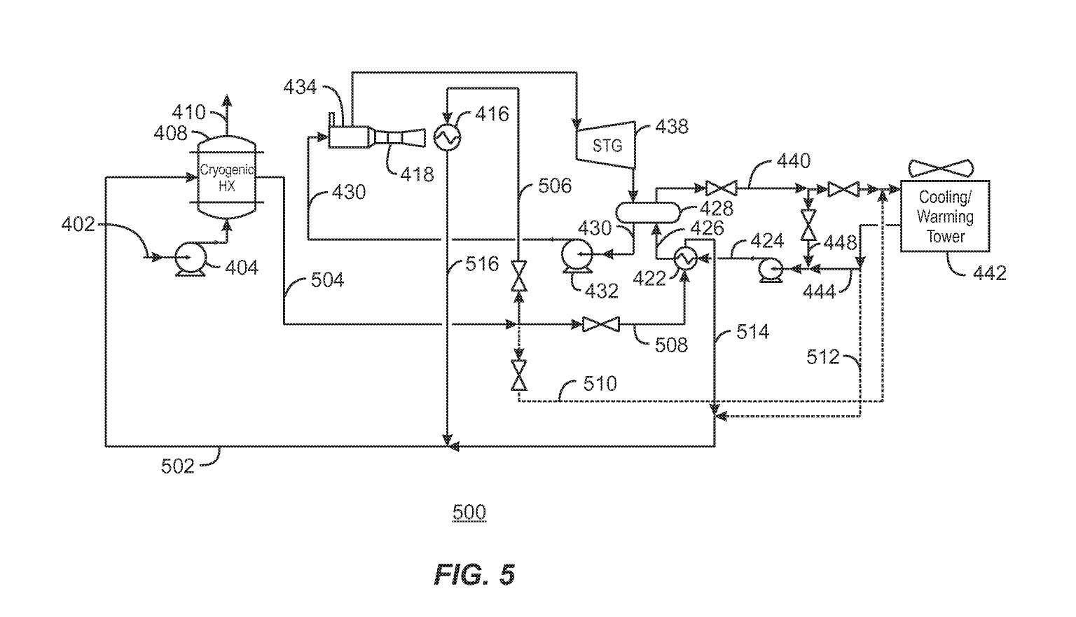

FIG. 3 is a process flow diagram of a LNG regasification method 300 that can be used in the systems discussed above. The method 300 starts at block 302 with the heating of the LNG with an intermediate fluid, for example, in a cryogenic heat exchanger 218 (FIG. 2). If the power plant is providing sufficient heat energy to the intermediate fluid, as determined at block 304, all of the intermediate fluid may be heated in the power plant, as indicated at block 306. In this situation, the cooling tower may not need to be operated to provide cooling duty of the steam condenser. However, if the power plant is off-line or operating at reduced capacity, the heat provided may be insufficient. Under those operating conditions, at block 308, a portion or even all of the intermediate fluid may be heated in a cooling tower used in warming service. Any number of plant configurations may be utilized in embodiments, as discussed with respect to FIGS. 4-6.

As used herein, “sufficient heat energy” is determined by the amount of heat needed to vaporize enough LNG to meet a market or pipeline demand for natural gas (NG). For example, if a power plant is completely operational and no NG is demanded, all cooling of the power plant can be performed by a cooling tower. As a NG demand increases, more heat energy is provided to the regasification process, until all cooling of the power plant is being provided by the regasification process. At that point, if further NG supply is demanded, the heat energy from the power plant would not be sufficient to vaporize the LNG needed to supply the NG demand and supplemental heat from other sources would be needed. Accordingly, the cooling tower may be operated in a warming tower configuration to provide the supplemental heat. Similarly, if the power plant was off-line, or operating at a reduced rate, supplemental heat energy from the cooling tower operated in a warming tower configuration may be used to provide sufficient heat to the regasification process.

### Combined Cycle Power Plant/LNG Terminal

FIG. 4 is a process flow diagram of a combined plant 400 having both a LNG regasification process and a combined cycle power plant. In the combined plant 400, LNG 402 is passed through a pump 404 that brings the LNG up to the sales pressure of the final gas. The LNG 402 is then regasified against a warm stream of heat transfer fluid (HTF) 406 in a cryogenic heat exchanger 408. The warm HTF has a temperature higher than cold LNG, higher than 40° F., higher than 50° F., and higher than 60° F. The natural gas 410 from the regasification process may be provided to a market and a portion may be used to fuel the power plant. The cryogenic heat exchanger 408 that is used as the LNG vaporizer may be a shell-and-tube type, a tube-in-tube type, or any number of other types of heat exchangers.

After passing through the cryogenic heat exchanger 408, the cold HTF 412 may be heated in the power plant. For example, a portion 414 of the cold HTF 412 can be heated in an inlet air cooler 416, in which the inlet air flow for a gas turbine generator (GTG) 418 is cooled. Cooling the inlet air increases the density of the inlet air and, thus, the power output of the GTG 418.

The HTF 412 may be heated in a number of other heat exchangers in the power plant in addition to, or instead of, the inlet air cooler 416. For example, another portion 420 of the HTF 412 may be circulated through a heat exchanger 422 to chill a water stream 424. The chilled water 426 may then be sent through a steam condenser 428. The condensed water 430 from the steam condenser 428 can be sent through a pump 432 for return to a heat recovery steam generator (HRSG) 434. In the HRSG 434, the water flow 430 is converted into steam 436 by heat transferred from the exhaust of the GTG 418 and the steam 436 is used to drive a steam turbine generator (STG) 438. The low pressure steam from the STG 438 is then returned to the steam condenser 428 to restart the cycle.

The hot water flow 440 from the steam condenser 428 can be sent to a cooling tower 442 to remove excess heat. The cooling tower may be an evaporative air transfer heat exchanger, in which water transfers heat from or to the atmosphere. If a fin-fan type cooling tower is used, then a heat transfer fluid may also be used to transfer heat from or to the atmosphere. The cooled water 444 is sent to a pump 446 and returned to the cooling cycle. A bypass 448 allows the water in the circulation loop around the steam condenser 428 to bypass the cooling tower 442, for example, if the portion 420 of the cold HTF 412 flowing through the heat exchanger 422 is sufficient to condense all or part of the steam from the STG 438. The cooling tower 442 also allows the power plant to operate when cold from the LNG 402 is no available, or is at an insufficient flow to remove all of the heat energy.

In other situations, the cold from the LNG 402 may be greater than the power plant can use for inlet air cooling, inter-cooling and steam condensing. In this situation, the cooling tower 442 may be operated in a reverse or warming tower configuration to provide some or all of the energy needed to vaporize the LNG 402, as indicated in FIG. 4 by dotted lines. In the warming mode, some, or even all, of the HTF 412 may be diverted to a stream 450 that can be sent through an intermediate heat exchanger 452. The intermediate heat exchanger 452 can be a plate-frame type, a shell-and-tube type, a tube-in-tube type, or a plate and shell type, or any combinations thereof. In the intermediate heat exchanger 452, the cold stream 450 may be warmed against a stream of warm water 454 from the cooling tower 442. The cooled water 456 from the intermediate heat exchanger 452 may then be returned to the cooling tower 442 to be warmed by ambient heat from the atmosphere. The warmed stream 458 of HTF 412 is returned to the circulation loop to be cycled back to the cryogenic heat exchanger 408 with the warm HTF 406 from the inlet cooler 416 and steam condenser 428. In the warming tower configuration, the cooling tower 442 also produces fresh water by condensing moisture out of the ambient air as the ambient air is cooled by the cold water. The cooling tower 442 can also be used in the warming tower configuration when the power plant is not operational or is shut-down for maintenance, ensuring continuous operation of the regasification terminal.

The HTF 412 may be single phase fluid including, for example, water and water/glycol mixtures, among others. Various phase change fluids, such as ammonia, propane, freon, or other refrigerants, may also be used as the HTF 412. If a single phase heat transfer fluid is used, the warm HTF 406 may have a temperature, for example, of about 32° F. or lower to about 70° F., or even above. The cold HTF 412 may have a temperature, for example, of about 32° F. or lower to about 45° F. or higher. The temperature ranges may be lower for a phase change fluid, for an example, −40° F. or higher if propane is used, as a substantial portion of the energy may be carried by the phase change itself.

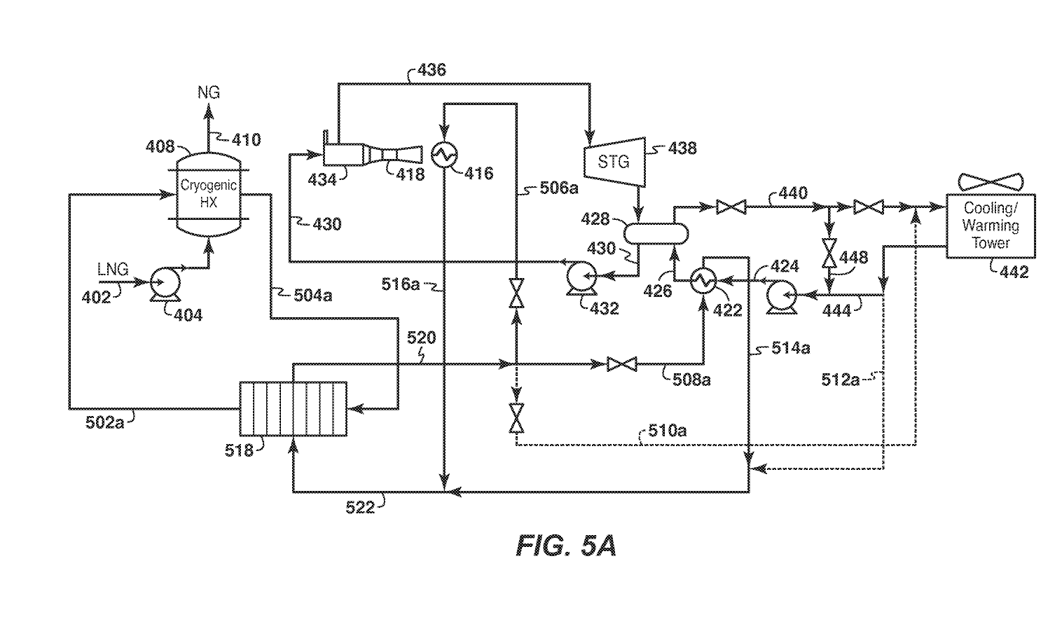

The intermediate heat exchanger 452 may or may not be needed depending on the choice of the heat transfer fluid that circulates between the cryogenic heat exchanger and the power plant. For example, if water is used as the heat transfer fluid, it may be combined with the water in the cooling tower loop. Thus, as discussed with respect to FIG. 5, the cooling and warming circulation may be a single integrated loop.

FIG. 5 is a process flow diagram of a combined plant 500 having both a LNG regasification process and a combined cycle power plant, using no separate intermediate heat transfer fluid. Like numbered items are as described with respect to FIG. 4. In the combined plant 500, water can be used to carry the heat flow through the process units of the plant. For example, a warm water stream 502 returned from the various heat exchangers, such as heat exchangers 416 and 422, and the cooling tower 442 can be used to provide heat energy to regasify the LNG 402 in the cryogenic heat exchanger 408. The resulting cold water stream 504 may be used to provide cooling to other parts of the plant.

In some embodiments, the cryogenic hear exchanger 408 may be a submerged combustion vaporizer (SCV). In a submerged combustion vaporizer, a fuel and oxidizer, such as natural gas and air, may be fed to a submerged burner nozzle in a water filled vessel. The flame from the burner heats the water, which transfers the heat to, e.g., submerged tubes, through which the LNG is flowing. So long as the heat from other sources, such as the power plant or the cooling tower (operated in warming tower mode) is sufficient, the SCV may be operated in a non-combustion mode. If an SCV is used as the cryogenic heat exchanger 408, the burner may be used if the heat from other sources is not sufficient.

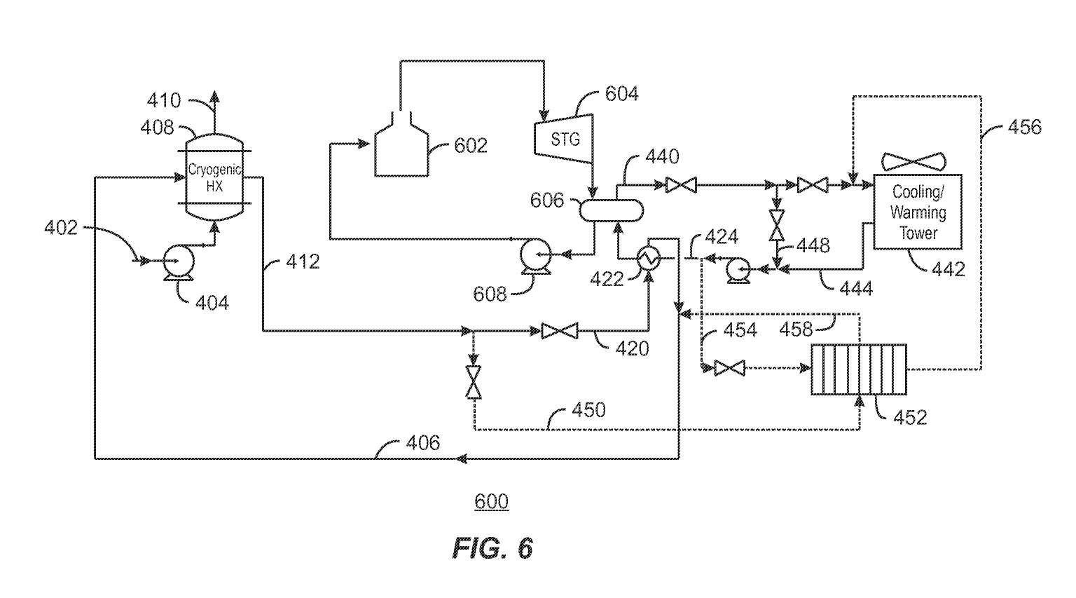

For example, a first portion 506 of the cold water stream 504 from the cryogenic heat exchanger 408 can be sent to the inlet cooler 416 to provide inlet cooling for a GTG 418. A second portion 508 can be sent through a heat exchanger 422 to provide cooling for a steam condenser 428, assisting in the condensation of a steam flow from the STG 438. A third portion 510 can be sent directly to the cooling tower 442 for warming by ambient air, for example, if the heat energy from the power plant is not sufficient to regasify the LNG 402. The warm water stream 512 from the cooling tower 442 can be combined with the return stream 514 from the heat exchanger 422 on the stream condenser 428, and the return stream 516 from the inlet cooler 416 on the GTG 418. The resulting warm water stream 502 can then be returned to the cryogenic heat exchanger 408 to dose the loop. It will be recognized that this is not the only configuration that may be used. Any number of heat sources may be cooled by the cold water stream 412 from the cryogenic heat exchanger 408. Further, the present techniques are not limited to combined cycle power plants that use a GTG 418 and a HRSG 434, as described above, but may also be used with power plants based on other power generation cycles, such as a steam power plant based on a Rankine cycle, as discussed with respect to FIG. 6.

FIG. 5A is similar to FIG. 5, except for the addition of a heat exchanger 518 wherein an intermediate heat transfer fluid, e.g., glycol, water, combinations thereof, etc., is used to regasify LNG by exchanging heat with another heat transfer fluid, such as water. Preferably, water is used in rest of the system including for GTG inlet cooling, the steam condenser, and the cooling tower. The flow lines designated with an “a”, i.e., 502a, 508a, 510a, 512a, 514a, and 516a, correspond with the flow lines of FIG. 5. However, the “a” denotes a potentially different flow rate, temperature, and composition compared to FIG. 5. The differences in flow rate and temperature caused by addition of heat exchanger 518, mass and energy balances, are readily determined by those skilled in the art. New lines 520 and 522 are the output and input, respectively, from heat exchanger 518.

FIG. 6 is a process flow diagram of a combined plant 600 having a LNG regasification plant in combination with a steam power plant. Like numbered units are as discussed with respect to FIG. 4. As shown in FIG. 6, a Rankine cycle power plant generally includes a steam generator 602, a steam turbine 604, a steam condenser 606, and a circulation pump 608. The heat energy from the steam condenser 606 can be removed in the cooling tower 442, or by exchanging energy with a portion 420 of the cold HTF 412 coming from the cryogenic heat exchanger 408. If the cooling from the portion 420 of the HTF 412 flowing through the heat exchanger 422 is sufficient, the cooling loop may bypass the cooling tower 442, flowing through bypass 448 instead.

However, the heat energy needed to regasify the LNG 402 may be greater than the heat energy from the steam condenser 606, or other sources in the power plant. If the heat energy from the power plant is not sufficient to regasify all of the LNG 402, a portion 454 of the HTF 412 may be sent through an intermediate heat exchanger 452 to be warmed by a stream of warm water 454 from the cooling tower 442. Further, if the power plant is not operational, all of the heat energy may be provided from the cooling tower 442.

The combined plant 600 may also include any number of other sources of heat energy for the power generation systems. For example, the power generation may be performed by harvesting heat from a geothermal energy source, such as a hot rock layer. This configuration may appear generally as shown in the combined plant 600 of FIG. 6. In this case, however, the steam generator 602 can be a geothermal heat source, such as a hot rock layer in the subsurface. The heat in the hot rock layer can be accessed by pumping water into cracks in the hot rock layer and harvesting the steam produced from the hot rock layer.

However, a geothermal energy source may not have sufficiently elevated temperature to efficiently provide energy to a Rankine cycle, for example, by boiling water. In this case, a secondary circulation fluid with a low boiling point, such as isobutane, an alcohol, or other phase change fluids, may be used in a binary cycle power plant. In a binary cycle power plant, the steam generator 602 would be replaced with a geothermal heat exchanger that could be used to flash the secondary circulation fluid against a flow of warmed water from a geothermal energy source. The secondary circulation vapor would be circulated through a turbine generator, before being condensed in a heat exchanger, such as heat exchanger 606. After condensation, the secondary circulation fluid would then be returned to the geothermal heat exchanger to close the loop. The energy from the condensation of the secondary circulation fluid may be removed by a portion 420 of a HTF 412 that is circulated through a heat exchanger 422. The large temperature differential that may exist between the HTF 412 and the geothermal energy source can increase the efficiency of binary cycle power generation and may also allow the use of marginal geothermal energy sources in a cost effective manner.

Any number of other configurations of combined plants could be used to take advantage of waste heat to regasify the LNG 402. For example, in addition to providing cooling to a condenser, a LNG regasification process may provide cooling for a sequestration process used to isolate CO₂ from an exhaust or stack gas. Further, the cooling tower 442 does not have to be based on a countercurrent water flow, but may be a fin-fan type heat exchanger. The fin-fan heat exchanger can be used to exchange energy from the circulating fluid with ambient air, for example, cooling the hot water flow 440 or warming the cooled water 456 from the intermediate heat exchanger 452. This configuration may be useful in areas where water resources are limited, such as in desert climates.

The configuration of the combined plants can provide a capability to optimize the utilization of the cold from the LNG 402, while reducing the environmental emissions associated with LNG regasification. For example, if a 250 megawatt (MW) power plant is installed at a regasification terminal with a 2 billion cubic foot per day (BCFD) capacity for the production of natural gas 410, the power plant may use cold from the LNG 402 that is the equivalent of only 1 BCFD of natural gas 410. Up to this point, the cooling tower 442 of the power plant may not be utilized for removing heat energy from the power plant.

When the sale of natural gas 410 exceeds 1 BCFD then the cooling tower 442 of the power plant can be operated as a warming tower to meet the sales demand. Similarly, if there is a reduced demand for electricity then both the power plant and the cooling tower 442 can be operated to meet the sales demand for the natural gas 410. To assist in meeting the demand for natural gas when power plant is not operational, the cooling tower 442 may be oversized so that enough LNG 410 can be regasified when it is operated in warming tower mode. It can be noted that life cycle economic analysis may suggest other combinations of power plant and warming tower sizes, thus the values discussed herein are merely examples, and are not limiting.

In summary, embodiments described herein provide benefits over fuel-fired vaporizers, including, for example, efficient use of installed equipment, such as cooling towers. Further, the techniques provided increased flexibility to use cold contained in LNG 402 and lower the amount of fuel used to vaporize LNG 410 and, thus, increasing the sales and revenue of natural gas 410 from the terminal. The elimination or reduction of fuel-fired vaporizers, may also decrease the associated capital expenditures and operating expenditures, and provide a reduction in the emissions, such as CO₂ and NOₓ, associated with the fuel consumption of a vaporizer in a terminal. The use of the cold from the LNG 402 also provides an increase in power plant efficiency and power output. In addition, condensation may produce substantial amounts of fresh water that may be used as feed water to a heat recovery steam generator 434.

While the present techniques may be susceptible to various modifications and alternative forms, the exemplary embodiments discussed above have been shown only by way of example. However, it should again be understood that the techniques is not intended to be limited to the particular embodiments disclosed herein. Indeed, the present techniques include all alternatives, modifications, and equivalents falling within the true spirit and scope of the appended claims.

What is claimed is:

1. A method for regasifying liquefied natural gas (LNG), comprising:
providing heat to a LNG regasification process from a power plant; and, if the heat is not sufficient,
providing additional heat to the LNG regasification process from a cooling tower operated in a warming tower configuration.

2. The method of claim 1, further comprising cooling water in the cooling tower when the power plant is operational.

3. The method of claim 1, further comprising using the cooling tower to warm a heat transfer fluid.

4. The method of claim 1, further comprising chilling intake air for a gas turbine by transferring heat to the LNG regasification process.

5. The method of claim 1, further comprising condensing steam from a steam turbine in a heat exchanger by transferring energy to the LNG regasification process.

6. The method of claim 1, further comprising transferring energy from the power plant to the LNG regasification process through a heat transfer fluid.

7. The method of claim 6, further comprising heating at least a portion of the heat transfer fluid against an net air stream for a gas turbine.

8. The method of claim 6, further comprising heating at least a portion of the heat transfer fluid against condensing steam in the power plant.

9. A method for vaporizing a cryogenic fluid, comprising:
vaporizing the cryogenic fluid against a heat transfer fluid;
providing heat energy to the heat transfer fluid from a power plant; and, if the heat from the power plant is not sufficient to vaporize the cryogenic fluid,
providing heat energy to the heat transfer fluid from a cooling tower of the power plant operating in a warming mode.

10. The method of claim 9, further comprising heating at least a portion of the heat transfer fluid against an net air stream for a gas turbine.

11. The method of claim 9, further comprising heating at least a portion of the heat transfer fluid against a condensing fluid in a power plant.

12. A system for regasifying liquefied natural gas, comprising:
a cryogenic heat exchanger configured to regasify a stream of LNG;
a power plant;
a cooling tower configured to operate in either a cooling or a warming mode; and
a heat transfer fluid, wherein the heat transfer fluid is configured to:
provide heat to the cryogenic heat exchanger from the power plant; and, if the heat is not sufficient,
provide at least a portion of the heat to the cryogenic heat exchanger from the cooling tower.

13. The system of claim 12, further comprising an intermediate heat exchanger configured to transfer the heat from the cooling tower to the heat transfer fluid.

14. The system of claim 13 where intermediate heat exchanger is a plate-frame type, a shell-and-tube type, a tube-in-tube type, or a plate and shell type, or any combinations thereof.

15. The system of claim 12, wherein the power plant comprises a combined cycle power plant, comprising a gas turbine generator and a heat recovery steam generator.

16. The system of claim 15, further comprising an inlet air cooler on a gas turbine generator configured to transfer the heat to the heat transfer fluid.

17. The system of claim 12, comprising a steam condenser, and a heat exchanger configured to transfer heat energy from the steam condenser to the heat transfer fluid.

18. The system of claim 12, wherein the power plant comprises a steam generator, a steam turbine generator, a steam condenser, and a recirculation pump.

19. The system of claim 12, wherein the power plant comprises a geothermal power plant.

20. The system of claim 19, wherein the geothermal power plant comprises a binary cycle power plant.

21. The system of claim 12, wherein the heat transfer fluid is a single-phase fluid.

22. The system of claim 12, wherein the heat transfer fluid is water or a water/glycol mixture.

23. The system of claim 12, wherein the heat transfer fluid is phase-change fluid.

24. The system of claim 12, wherein the heat transfer fluid is propane, freon, a phase change refrigerant, or any combinations thereof.

25. The system of claim 12, wherein the cooling tower is an evaporative type cooling tower or a fin-fan cooling tower.

26. The system of claim 12, wherein the cryogenic heat exchanger is a submerged combustion vaporizer (SCV).

27. The system of claim 26, wherein the SCV is used in combustion mode to provide additional heat.

28. The system of claim 12, wherein the cryogenic heat exchanger is a shell-and-tube vaporizer.
